(19) United States
(12) Patent Application Publication
(10) Pub. No.: US 2010/0061640 A1
(43) Pub. Date: Mar. 11, 2010

(54) METHOD AND APPARATUS FOR DETECTING CODE OF HOLOGRAPHIC DATA PAGE

(75) Inventors: Po-Chang Chen, Taipei County (TW); Chih-Hao Liu, Taichung City (TW); Chien-Fu Tseng, Yunlin County (TW); Chia-Hang Ho, Taipei City (TW); Feng-Hsiang Lo, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/548,450

(22) Filed: Aug. 27, 2009

(30) Foreign Application Priority Data
Sep. 8, 2008 (TW) 97134453

(51) Int. Cl. G06K 9/68

(52) U.S. Cl. 382/218

(57) ABSTRACT

A method and an apparatus for detecting code of a holographic data page are provided. First, image information of at least one special pattern in the holographic data page is captured, and the captured image information is integrated into a characteristic symbol (CS) of the holographic data page. Then, the CS of the holographic data page is compared with a plurality of predetermined characteristic symbols (PCSs) to obtain a similarity between the CS and each of the PCSs. Thereafter, the PCS having the highest similarity to the CS is selected as the code information of the holographic data page.

### CROSS-REFERENCE TO RELATED APPLICATION

This application claims the priority benefit of Taiwan application serial no. 97134453, filed on Sep. 8, 2008. The entirety of the above-mentioned patent application is hereby incorporated by reference herein and made a part of specification.

### BACKGROUND OF THE INVENTION

1. Technical Field

The present invention generally relates to a holographic data storage (HDS) technique, and more particularly, to a method and an apparatus for detecting code information in a holographic data page.

2. Background

HDS is a technique that records interference patterns containing data messages on a storage material/medium as a hologram. The interference patterns are produced by optical interference between an object beam and a reference beam. By adjusting the reference beam angle, wavelength, or media position, a multitude of holograms can be stored on a single volume. To access these holograms, a laser beam, performed as the reference beam, is projected onto the storage material/medium to illuminate the appropriate interference pattern and the light diffracts on the interference pattern is read onto a detector, so as to reconstruct a holographic data page. Multiple data pages can be read and treated as a data book.

It is noted that besides the data to be stored, some information related to the system or the medium such as address information of data pages or data books, capacity or manufacturer information of the storage medium are recorded in a medium together. Such information is expected frequently to be correctly identified even if an optimal read state has not yet been reached.

Therefore, in order to detect/decode a data image accurately in a holographic data storage system (HDSS), at least one fixed region is defined in a hologram. A plurality of special patterns, usually referred as reference marks (RM), are placed into the fixed regions and used as a basis for image (i.e. hologram) positioning and image correction. There are two kinds of method for image positioning and image correction. One method is to move some elements in the HDS system, for example, the storage material/medium, such that an optimal read state can be reached. The other method is to directly process an image captured by an image sensor through a digital image processing technique. Regardless of which method is adopted, at least one set of correction information is necessary to be referenced and the most effective way is to place RMs in the holographic data page.

### SUMMARY

According to one embodiment, a code detection method for a holographic data page is disclosed. The code detection method is applied for detecting code information in the holographic data page, in which the code information is recorded in the holographic data page through arrangement of reference marks (RM).

According to another embodiment, a code detection apparatus for a holographic data page is disclosed. The apparatus compares a characteristic symbol (CS) of the holographic data page with a plurality of predetermined characteristic symbols (PCSs), and selects the PCS which is most similar to the CS of the holographic data page as code information of the holographic data page, so as to accurately detect the code information.

According to another embodiment, a code detection method for a holographic data page is disclosed. The code detection method is suitable for detecting code information in the holographic data page. First, image information of at least one special pattern in the holographic data page is captured, and the captured image information is combined to form a CS of the holographic data page. Then, the CS of the holographic data page is compared with a plurality of PCSs, and the PCS having the highest similarity to the CS is selected as the code information of the holographic data page.

According to another embodiment, in the step of comparing the CS of the holographic data page with the PCSs and selecting the PCS having the highest similarity to the CS as the code information of the holographic data page, a similarity value between the CS and each of the PCSs is obtained respectively, and the PCS having the highest similarity value to the CS is selected as the code information of the holographic data page.

According to another embodiment, the step of obtaining the similarity between the CS and each of the PCSs includes calculating an inner product or a norm of the image information of the CS and the corresponding image information in each of the PCSs as the similarity.

According to another embodiment, the holographic data page includes a plurality of blocks, and these blocks are classified into a holographic data area and a pattern placement area (PPA).

According to another embodiment, before the step of capturing the image information of the special pattern in the holographic data page, the code detection method further obtains position information of the special pattern in the holographic data page by using an image recognition technique, and performs an image recovery process to the holographic data page according to the position information, in which the image recovery process includes at least one of shift and rotation, image size correction, and distortion correction.

According to another embodiment, in the step of performing the image recovery process to the holographic data page according to the position information, position information of the PPAs which are not placed with the special pattern and position information of the PPAs which fail in detecting the special pattern are calculated by using an interpolation or an extrapolation according to the detected position information of the PPAs in the holographic data page. The data image in the holographic data page and the special pattern in the PPAs are corrected by using a numerical method according to the position information of the PPAs.

According to another embodiment, the holographic data page includes at least three PPAs, and at least three of the PPAs enclose a holographic data area, wherein the holographic data area may or may not record data.

According to another embodiment, the special pattern is placed into the PPAs according to a coding method. The coding method includes recording the code information in various special patterns, in which the arrangement of the special pattern conforms to an equal power rule. Moreover, the arrangement of the special pattern comprises placing or not placing the special pattern in the PPAs, or placing different special patterns in the PPAs.

According to another embodiment, the coding method includes recording the code information by placing or not placing the special pattern in the PPAs or recording the code information by placing various special patterns in the PPAs. Wherein, the code information is contained in the codes which are produced by encoding data/information.

According to another embodiment, the image information of the CSs is recorded as a matrix, and the image information includes a light intensity or a correlation corresponding to the special pattern.

According to another embodiment, the code information includes position information, system information, or recording medium information of the holographic data page.

According to another embodiment, a code detection apparatus for a holographic data page includes an image capturing unit, a storage unit, and a processing unit. The image capturing unit captures image information of at least one special pattern in the holographic data page and integrates the captured image information into a CS of the holographic data page. The storage unit stores a plurality of PCSs. The processing unit compares the CS of the holographic data page with the PCSs and selects the PCS having the highest similarity to the CS as code information of the holographic data page.

According to another embodiment, the processing unit includes a similarity calculation unit and a comparison unit. The similarity calculation unit calculates an inner product or a norm of the image information in the CS and the corresponding image information in each of the PCSs as a similarity value between the CS and the PCS. The comparison unit compares the similarity values between the CS and each of the PCSs and selects the PCS having the highest similarity value to the CS as the code information of the holographic data page.

According to another embodiment, the code detection apparatus further includes an image correction unit. The image correction unit detects position information of the special pattern in the holographic data page by using an image recognition technique and performs an image recovery process to the holographic data page captured by the image capturing unit according to the position information. The image recovery process includes at least one of a shift and rotation, a size correction, and a distortion correction.

According to another embodiment, the holographic data page includes a plurality of blocks, and the blocks are classified into a holographic data area and a PPA. The image correction unit calculates position information of the PPAs which are not placed with the special pattern and position information of the PPAs which fail in detecting the special pattern by using an interpolation or an extrapolation according to the detected position information of the PPAs in the holographic data page and corrects the special pattern in the PPAs by using a numerical method according to the position information of all the PPAs in the holographic data page.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a holographic data page according to an embodiment.

FIG. 2 is a diagram illustrating the code detection in a holographic data page according to another embodiment.

FIG. 3 is a block diagram of a code detection apparatus for a holographic data page according to another embodiment.

FIG. 4 is a flowchart of a code detection method for a holographic data page according to another embodiment.

FIG. 5 is a flowchart of a code detection method for a holographic data page according to another embodiment.

FIG. 6 is a schematic diagram of a code detection method for a holographic data page according to another embodiment.

FIG. 7 is a schematic diagram of a code detection method for a holographic data page according to another embodiment.

### DESCRIPTION OF THE EMBODIMENTS

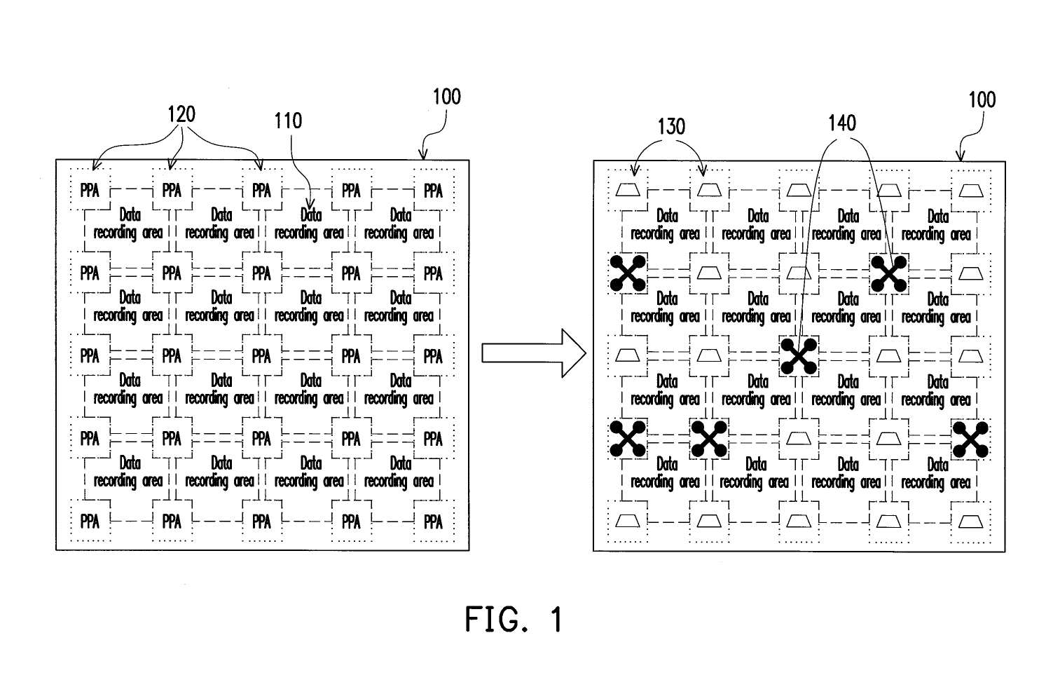

FIG. 1 is a schematic diagram of a holographic data page according to an embodiment. Referring to FIG. 1, data recording areas 110 and PPAs 120 are defined in the holographic data page 100. The PPAs 120 may be placed with special patterns (for example, the PPAs 130) or may not be placed with any special pattern (for example, the PPAs 140). Code information is encoded in the holographic data page through the arrangement and style of the special patterns. Namely, each arrangement of the special patterns represents code information, and the code information may be system information (e.g. HDSS specification, or system manufacturing information, etc.) or medium related data (e.g. physical specification, data format, the address information of a data page or a data book and the capacity or manufacturer information of a storage medium, etc.). It can be noted that the holographic data page includes at least three PPAs, and at least three of the PPAs enclose a data recording area. For example, the holographic data page 100 in FIG. 1 includes 25 PPAs, and every four PPAs enclose a data recording area.

After the holographic data page is written into a storage material/medium, the image read by an image sensor is affected by optical path, material, noises, and various writing conditions and therefore the brightness of each special pattern is changed. In this case, effective detection method and apparatus have to be provided to detect the code information encoded in the special patterns in the holographic data page.

Accordingly, a code detection method applies an equal power rule to arrange special patterns, and the arrangement of the special patterns implies the code information. Herein the equal power rule refers to that all the PCSs in a PCS set have the same sum of squares of pixel values. As to a method for encoding binary pixel values (for example, 0 and 1), the equal power rule represents that all the PCSs contain the same numbers of zero-valued and non-zero-valued pixels. Based on such characteristic, the following code detection method can be obtained.

In an embodiment, the arrangement of special patterns can be denoted by following Mm×Nn matrix S:

$$S = [ \begin{matrix}{C}_{1} & {C}_{2} & … & {C}_{N} \\ {C}_{N + 1} & {C}_{N + 2} & … & {C}_{2 N} \\ ⋮ & ⋮ & ⋱ & ⋮ \\ {C}_{( M - 1 ) N + 1} & {C}_{( M - 1 ) N + 2} & … & {C}_{MN}\end{matrix} ] , \qquad ( 1 )$$

wherein C₁, C₂, . . . , C_{MN} are all matrices with m×n dimensions, these matrices may be the light intensities of the special patterns, and the dimension m×n thereof is corresponding to the pixel number of one special pattern in the image sensor. Besides, C₁, C₂, . . . , C_{MN} are sub matrices in the matrix S, and each of the sub matrices represents a special pattern. If cᵢ is defined as a vector formed by the column elements of the sub matrix Cᵢ, such as Cᵢ={cᵢ(p, q)}, in which cᵢ represents elements of the matrix, and p and q respectively represent index of columns and rows, then cᵢ is expressed as:

cᵢ=[cᵢ(1,1) cᵢ(1,2) . . . cᵢ(1,n) . . . cᵢ(m,1) cᵢ(m,2) . . . cᵢ(m,n)]^{T} (2),

and accordingly the matrix S can be expressed as the following vector:

s=[c₁^{T} c₂^{T} . . . c_{MN}]^{T} (3).

Foregoing equations can be used in the derivation of inner products and norms.

If C₁, C₂, . . . , C_{MN} respectively represent different special patterns, the matrix S has 2^{MN} kinds of permutations and combinations. Assuming that there are only k kinds of combinations due to the restriction of the equal power rule, and the k kinds of combinations are respectively denoted by symbols S₁,S₂, . . . ,Sₖ or by vectors s₁, s₂, . . . , sₖ, then each of the symbols represents different code information.

In addition, if matrices Rᵢ, i=1, . . . , MN, is used for representing the special pattern image received by the image sensor and rᵢ, i=1, . . . , MN, is the vectorial representation of Rᵢ, and the received CS in vector form is r=[r₁^{T} r₂^{T} . . . r_{MN}^{T}]^{T}. Assuming vε{s₁, s₂, . . . , sₖ} is the PCS vector recorded in the holographic data page, then the task for detecting the special patterns is to recognize the received vector r, that is the CS, into the previously recorded vector v. Generally speaking, under the affection of optical path, material, image sensor, and noises, the vector r and the vector v have following relationship:

r=a(v+n)+b (4),

in which a is a positive gain, b is a bias vector, n is a noise vector, and elements in the vector b are all positive real numbers. The a, b, and n are usually unknown, and elements in the vector n may be white Gaussian noises. The received vector r is compared with a plurality of PCS vectors s₁, s₂, . . . , sₖ through a minimum distance detection, and the most similar vector is selected as the previously recorded PCS. The method described above is highly robust to the gain a and the bias vector b, namely, the detection performance thereof is not affected by the two unknown parameters. The vector \hat{v} having the highest similarity to the vector r can be obtained through the following equation:

$$\hat{\underline{v}} = {arg}_{i} min {‖ {\underline{s}}_{i} - \underline{r} ‖}^{2} , \qquad ( 5 )$$

in which i=1, 2, . . . , k, and ∥·∥ is the Euclidean norm. The equation (4) is substituted into the equation (5) to obtain:

$$\hat{\underline{v}} = {arg}_{i} min {‖ {\underline{s}}_{i} - a ( \underline{v} + \underline{n} ) + \underline{b} ‖}^{2} . \qquad ( 6 )$$

Foregoing equation is further derived to obtain:

$$\hat{\underline{v}} = {arg}_{i} min {\sum }_{j} {\{ {\underline{s}}_{i} ( j ) - [ a \underline{v} ( j ) - a \underline{n} ( j ) + \underline{b} ( j ) ] \}}^{2} \qquad ( 7 )$$

in which sᵢ(j) is the j^{th} element of the PCS vector sᵢ, and v(j), n(j), and b(j) are respectively the j^{th} element of the vectors v, n, and b. By expanding foregoing equation and setting the constant thereof as kₒ, the following equation is obtained:

$$\hat{\underline{v}} = {arg}_{i} min \{ {\sum }_{j} [ {\underline{s}}_{i}^{2} ( j ) - 2 {\underline{s}}_{i} ( j ) \underline{r} ( j ) ] + {k}_{0} \} \qquad ( 8 )$$

Since all the CSs have the same power, namely,

$${\sum }_{j} {\underline{s}}_{i}^{2} ( j )$$

is a constant and kₒ is also a constant, the equation (8) can be simplified into:

$$\hat{\underline{v}} = {arg}_{i} min \{ {\sum }_{j} {\underline{s}}_{i} ( j ) \underline{r} ( j ) \} = {arg}_{i} min ( {\underline{s}}_{i}^{T} \underline{r} ) . \qquad ( 9 )$$

It can be understood from foregoing equation that the minimum distance detection can be accomplished by simply calculating an inner product of the received CS vector r and each of the PCS vectors s₁, s₂, . . . , sₖ, and the estimate PCS \hat{v}ε{s₁,s₂, . . . ,sₖ} having the maximum inner product is the desired PCS. According to the detection method, the PCS which is most similar to the CS is found through the minimum distance detection so that the correctness of the detection can be improved to make \hat{v}=v, so as to obtain the previously recorded PCS vector.

In the detection method described above, each PCS is composed of zero or non-zero elements. Thus, the item sᵢ(j)=0 can be ignored during the calculation process. As a result, the burden of calculations can be reduced and the hardware circuit can be simplified.

Even though foregoing derivation is carried out based on vectors, in an actual implementation of circuits or microcomputers, the CSs or PCSs may also be expressed as matrices or tables, and calculations may be performed to the received CS and the PCSs by means of element-by-element multiplication of the matrices or tables. After that, the detected PCS may be input into a decoding unit so as to decode the PCS back to the previously recorded information.

Based on the concept described above, the present invention provides a method and an apparatus for detecting code information in a holographic data page, in which a received CS is compared with a plurality of PCSs, an inner product of the received CS and each of the PCSs is calculated, and the PCS having the largest inner product with the CS is selected as the code information. Thereby, the performance in detecting the code information is improved. Embodiments will be described in detail below.

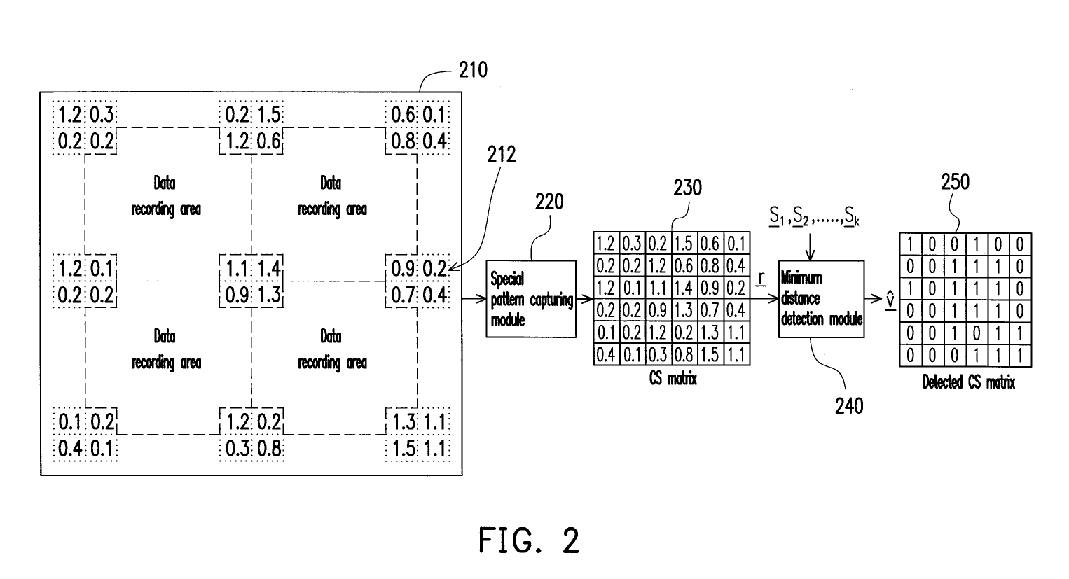

FIG. 2 is a diagram illustrating the CS detection in a holographic data page according to one embodiment. Referring to FIG. 2, the holographic data page 210 is an image read from a holographic material. In the embodiment, the holographic data page 210 has no misalignment or distortion, or an image recovery process has been performed to the holographic data page 210. In this case, the light intensities of all the PPAs 212 in the captured holographic data page 210 can be integrated into a CS matrix 230 by a special pattern capturing module 220.

A minimum distance detection module 240 performs a minimum distance detection to the CS matrix 230 and a plurality of PCS matrices. The minimum distance detection module 240 compares foregoing calculation results and selects a PCS matrix 250 which is most similar to the CS matrix 230 as the detected code information.

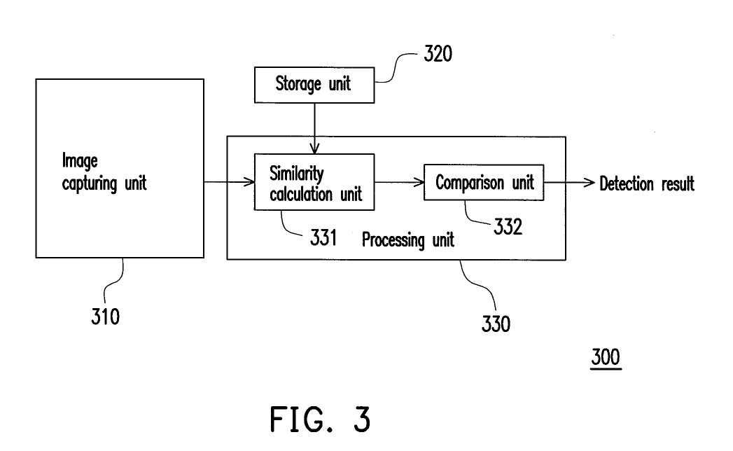

FIG. 3 is a block diagram of a code detection apparatus for a holographic data page according to the embodiment. Referring to FIG. 3, in the present embodiment, the code detection apparatus 300 includes an image capturing unit 310, a storage unit 320, and a processing unit 330. The functions of foregoing components will be respectively described below.

The image capturing unit 310 captures an image (for example, the holographic data page 210) from holographic material. After that, the image capturing unit 310 retrieves image information of at least one special pattern in the holographic data page, in which the captured image information becomes the CS of the holographic data page. Taking the holographic data page 210 in FIG. 2 as an example, the holographic data page 210 includes 9 PPAs, and the light intensities detected in the PPAs are integrated into a CS matrix 230.

The storage unit 320 stores a plurality of PCSs. Each of the PCSs is pre-coded through different style or arrangement of special patterns based on an equal power rule and is stored in the storage unit 320 for subsequent comparison and determination.

The processing unit 330 compares the CS of the holographic data page obtained by the image capturing unit 310 with the PCSs stored in the storage unit 320 and selects the PCS having the highest similarity to the CS as the detection result, in which the PCS having the highest similarity to the CS is considered as the code information in the holographic data page.

To be specific, the processing unit 330 includes a similarity calculation unit 331 and a comparison unit 332. The similarity calculation unit 331 calculates an inner product or a norm of the image information in the CS and the corresponding image information in each of the PCSs as the similarity value between the CS and the PCS. The comparison unit 332 compares the similarity value and selects the PCS having the highest similarity value to the CS as the code information of the holographic data page.

A code detection method is to detect code information in a holographic data page, which will be described below with reference to an embodiment.

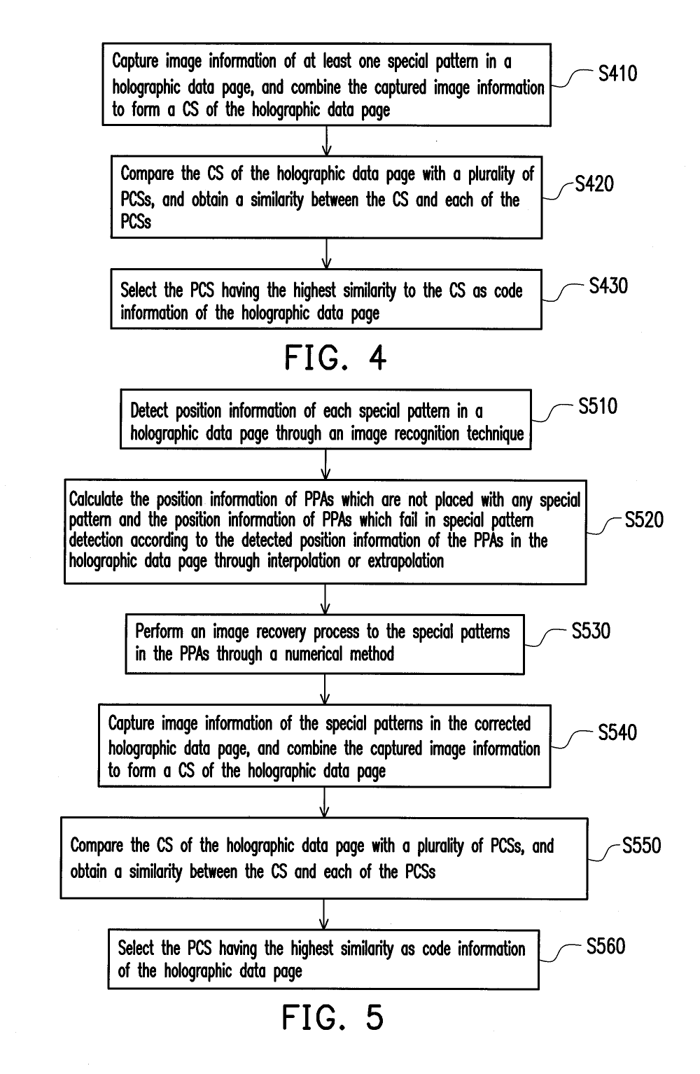

FIG. 4 is a flowchart of a code detection method for a holographic data page according to another embodiment. Referring to FIG. 4, the code detection method in the present embodiment is suitable for the code detection apparatus 300 described above for detecting code information in the holographic data page.

First, image information of at least one special pattern in the holographic data page is captured, and the captured image information is integrated and served as a CS of the holographic data page (step S410). The style or arrangement of the special pattern conforms to an equal power rule, and the code information is encoded in the style or arrangement of the special pattern.

Then, the CS of the holographic data page is compared with a plurality of PCSs, and the similarity between the CS and each of the PCSs is obtained (step S420). The value of the similarity may be obtained by multiplying the pixel value in the image information of the CS by the element of the PCS matrix/vector and adding up all the products. In short, the similarity value is obtained by calculating the inner product of the CS and the PCSs.

Eventually, the PCS having the highest similarity to the CS is selected as the code information in the holographic data page (step S430). Based on the method described above, the PCS producing the highest inner product has the highest similarity value to the CS, and the PCS having the highest similarity value is the code information in the holographic data page.

Through the apparatus and method described above, one of a plurality of PCSs is selected as the detection result of the code information. Since each element in the PCS has a zero or non-zero value, during the calculation of the inner products, those items multiplied by zero can be ignored so that the burden of calculations can be greatly reduced.

It should be noted that the image captured by an image sensor is usually misaligned or distorted. Besides, if a different coding method is used, some PPAs may not be placed with any special pattern, namely, there is no special pattern in these PPAs for providing reference position information. In addition, due to the affection of optical path, material, noises, and various writing conditions, the detection of some special patterns may be failed due to the bad image quality. Therefore, to recover the image, the position information of the PPAs which are not placed with any special pattern and the position information of the PPAs which fail in detecting any special pattern have to be calculated by using the detected position information of the PPAs, and an image recovery process is performed to the captured holographic data page according to the reference position information of the PPAs in order to provide the recovered image for code detection. Foregoing concept will be described below with reference to another embodiment.

Regarding the problem that some PPAs are not placed with any special pattern or the special patterns therein cannot be detected and therefore complete CS information cannot be obtained, the present embodiment provides a technique in which position information of PPAs is obtained by using position information of adjacent PPAs through interpolation or extrapolation. Referring to FIG. 5, in the present embodiment, the position information of each special pattern in the holographic data page is detected through an image recognition technique, such as a cross-correlation technique (step S510). Then, the position information of the PPAs which are not placed with any special pattern and the position information of the PPAs which fail in special pattern detection are calculated through interpolation or extrapolation according to the position information of the PPAs that have been detected in the holographic data page (step S520).

After the position information of all the PPAs in the holographic data page is obtained either by detection or estimation, an image recovery process is performed to the special patterns in the PPAs through a numerical method (step S530). The image recovery process may include a shift correction, a rotation correction, a size correction, or a distortion correction; but not limited.

After the image correction is completed, the next step is to recognize the information implied in the arrangement of the special patterns in the holographic data page. However, if quality of the optics of the system is not satisfactory, or data cannot be written into the holographic material correctly, or even the image sensor or the holographic material is contaminated, the image quality of the special patterns placed in the holographic data page is always affected. In this case, the arrangement of the special patterns (i.e., the CS) can be detected or decoded through the code detection method described in foregoing embodiment.

To be specific, image information of the special patterns in the recovered holographic data page is first captured, and the captured image information is integrated to be the CS of the holographic data page (step S540). Then, the CS of the holographic data page is compared with a plurality of PCSs, and a similarity between the CS and each of the PCSs is obtained (step S550). Finally, the PCS having the highest similarity is selected as the code information of the holographic data page (step S560). Foregoing steps S540˜S560 are the same or similar to the steps S410˜S430 in the embodiment described above therefore will not be described herein.

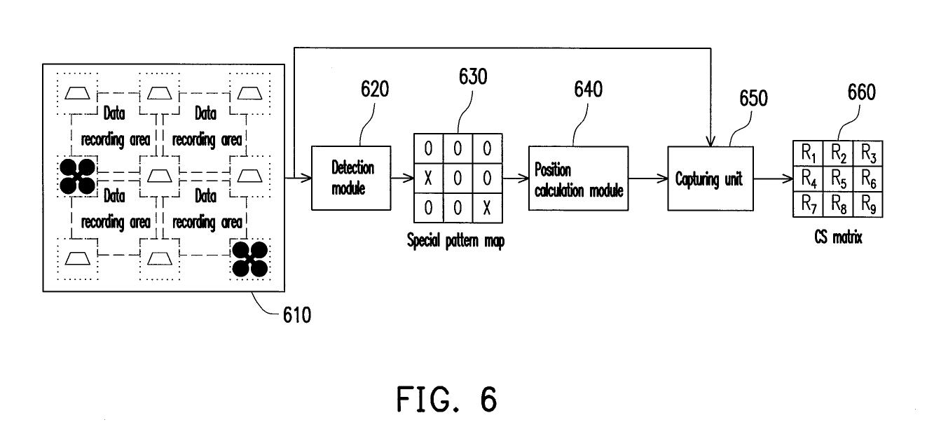

FIG. 6 is a schematic diagram of a code detection method for a holographic data page according to another embodiment. Referring to FIG. 6, the holographic data page 610 has 9 PPAs, and the arrangement of the PPAs conforms to an equal power rule. An image sensor captures the holographic data page 610, and then a detection module 620 detects which PPAs in the holographic data page 610 are placed with special patterns (i.e., the parts marked with “o” in the special pattern map 630) or which PPAs in the holographic data page 610 are not placed with any special pattern (i.e., the parts marked with “x” in the special pattern map 630).

By using an interpolation or an extrapolation method, a position calculation module 640 calculates the position information of the PPAs which are not placed with the special patterns according to the detected position information of the PPAs. Similarly, the position calculation module 640 also calculates the position information of the PPAs which fail in special pattern detection. Then, a capturing unit 650 captures the image information of the special patterns in each of the PPAs by using the detected and calculated position information of the PPAs, so as to obtain a CS matrix 660. The elements in CS matrix 660 are the image information of the special patterns. Herein the purpose of detecting the special patterns is to find out where there are PPAs and to obtain their positions. These detected PPAs and the position information thereof can be used as the calculation reference for the positions of other PPAs and image correction.

It should be noted that in the meantime that the special pattern image 630 is obtained, the captured image information of the special patterns are collected and integrated into a CS matrix 660. The elements in the CS matrix 660 may not be light intensities; instead, the correlations obtained while detecting the special patterns may also be used as the elements of the CS matrix 660. However, the quantitative index of each element in the CS matrix 660 should be consistent with the index of the coded PCs.

The PCS which is most similar to the CS of the holographic data page can be found by simply inputting the CS matrix 660 into the code detection apparatus 330 as shown in FIG. 3. Herein, the CS matrix 660 is equivalent to r in foregoing equation (9). The original matrix can be easily converted into a vector to calculate the inner products. Or, the inner products may also be calculated by multiplying the elements in the CS matrix 660 by the elements in each of the PCSs in the storage unit 320. Eventually, the detected CS is input into a decoding unit to be decoded into the original information.

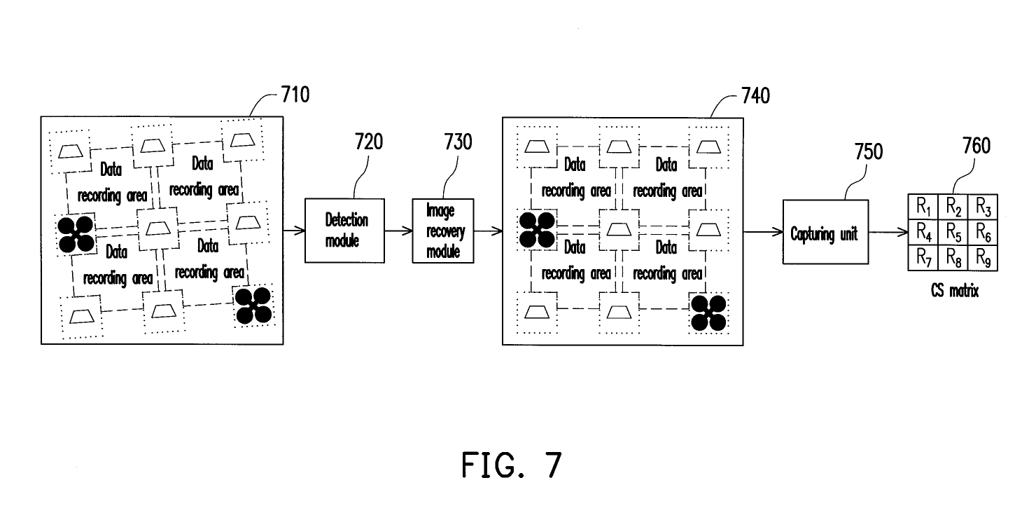

FIG. 7 is a schematic diagram of a code detection method for a holographic data page according to another embodiment. Referring to FIG. 7, in the present embodiment, the holographic data page 710 has 9 PPAs, and the placement of the special patterns in these PPAs conforms to an equal power rule. An image sensor captures an image of the holographic data page 710, and a detection module 720 and an image recovery module 730 recovers the holographic data page 710 from any misalignment or distortion to obtain a corrected image 740.

Because the corrected image 740 is recovered, the positions of the PPAs therein are known. Therefore, the light intensities of all the PPAs in the corrected image 740 are collected and integrated by a capturing unit 750 into a CS matrix 760 through the method described in foregoing embodiment, and then the CS matrix 760 is input into the processing unit 330 in FIG. 3 to obtain the PCS which is most similar to the CS of the holographic data page as the detection result. Similarly, the detected CS can be input into a decoding unit to be decoded into the original information.

It can be understood from foregoing embodiments that regardless of whether a captured original image or a corrected image is used, it is within the scope as long as a numerical matrix, a vector, or a table (for example, a CS matrix) which represents the CS information of the holographic data page is produced from the image, and the information is compared with each symbol in a plurality of PCSs to obtain the most similar CS.

As described above, the present invention provides a code detection method and a corresponding apparatus for a holographic data page, in which special patterns are arranged in the holographic data page, and code information is encoded in the arrangement of the special patterns. Thereby, a good detection performance of the code information can be provided even when some of the special patterns are interfered by gains, misalignment, or noises.

It will be apparent to those skilled in the art that various modifications and variations can be made to the structure without departing from the scope or spirit of the invention. In view of the foregoing, it is intended that the present invention cover modifications and variations of this invention provided they fall within the scope of the following claims and their equivalents.

What is claimed is:

1. A code detection method for a holographic data page, comprising:
capturing image information of at least one special pattern in the holographic data page, and integrating the captured image information into a characteristic symbol (CS) of the holographic data page; and
comparing the CS of the holographic data page with a plurality of predetermined characteristic symbols (PCSs) to select the PCS which has a highest similarity to the CS as code information of the holographic data page.

2. The code detection method according to claim 1, wherein the step of comparing the CS of the holographic data page with the PCSs to select the PCS which has the highest similarity to the CS as the code information of the holographic data page comprises:
obtaining a similarity value between the CS and each of the PCSs; and
selecting the PCS having the highest similarity value to the CS as the code information of the holographic data page.

3. The code detection method according to claim 2, wherein the step of obtaining the similarity value between the CS and each of the PCSs comprises:
calculating an inner product or a norm of the image information in the CS and the image information in each of the PCSs.

4. The code detection method according to claim 1, wherein the holographic data page comprises a plurality of blocks, and the blocks are classified into holographic data area and pattern placement area (PPA).

5. The code detection method according to claim 4, wherein before the step of capturing the image information of the special pattern in the holographic data page, the code detection method further comprises:
detecting position information of the special pattern in the holographic data page by using an image recognition technique; and
performing an image recovery process to the holographic data page according to the position information.

6. The code detection method according to claim 5, wherein the step of performing the image recovery process to the holographic data page according to the position information comprises:
calculating position information of the PPAs which are not placed with the special pattern and position information of the PPAs which fail in detecting the special pattern by using an interpolation or an extrapolation according to the detected position information of the PPAs in the holographic data page; and
correcting the special pattern in the PPAs by using a numerical method according to the position information of all the PPAs in the holographic data page.

7. The code detection method according to claim 5, wherein the image recovery process comprises at least one of a shift and rotation, an image size correction, and a distortion correction.

8. The code detection method according to claim 4, wherein the holographic data page comprises at least three PPAs, and the at least three PPAs enclose a holographic data area.

9. The code detection method according to claim 4, wherein the holographic data area may or may not record data.

10. The code detection method according to claim 4, wherein the special pattern is placed into the PPAs according to a coding method.

11. The code detection method according to claim 10, wherein the coding method comprises recording the code information in a style or arrangement of the special pattern.

12. The code detection method according to claim 10, wherein the style or arrangement of the special pattern conforms to an equal power rule.

13. The code detection method according to claim 12, wherein the coding method comprises recording the code information by placing or not placing the special pattern in the PPAs.

14. The code detection method according to claim 12, wherein the coding method comprises recording the code information by placing the special pattern of different styles in the PPAs.

15. The code detection method according to claim 1, wherein the CS comprises recording the image information as a matrix.

16. The code detection method according to claim 1, wherein the code information comprises position information, system information, or recording medium information of the holographic data page.

17. A code detection apparatus for a holographic data page, comprising:
an image capturing unit, for capturing image information of at least one special pattern in the holographic data page and integrating the captured image information into a CS of the holographic data page;
a storage unit, for storing a plurality of PCSs; and
a processing unit, for comparing the CS of the holographic data page with the PCSs and selecting the PCS having a highest similarity to the CS as code information of the holographic data page.

18. The code detection apparatus according to claim 17, wherein the processing unit comprises:
a similarity calculation unit, for calculating an inner product or a norm of the image information in the CS and the image information in each of the PCSs as a similarity value between the CS and the PCS; and
a comparison unit, for comparing the similarity values between the CS and the PCSs and selecting the PCS having the highest similarity value to the CS as the code information of the holographic data page.

19. The code detection apparatus according to claim 17, further comprising:
an image correction unit, for detecting position information of the special pattern in the holographic data page by using an image recognition technique and performing an image recovery process to the holographic data page captured by the image capturing unit according to the position information.

20. The code detection apparatus according to claim 19, wherein the holographic data page comprises a plurality of blocks, and the blocks are classified into holographic data area and PPA.

21. The code detection apparatus according to claim 20, wherein the image correction unit comprises calculating position information of the PPAs which are not placed with the special pattern and position information of the PPAs which fail in detecting the special pattern by using an interpolation or an extrapolation according to the detected position information of the PPAs in the holographic data page and correcting the special pattern in the PPAs by using a numerical method according to the position information of all the PPAs in the holographic data page.

22. The code detection apparatus according to claim 19, wherein the image recovery process comprises at least one of a shift and rotation, an image size correction, and a distortion correction.

23. The code detection apparatus according to claim 20, wherein the holographic data page comprises at least three PPAs, and the at least three PPAs enclose a holographic data area.

24. The code detection apparatus according to claim 23, wherein the holographic data area may or may not record data.

25. The code detection apparatus according to claim 17, wherein a style or arrangement of the special pattern conforms to an equal power rule.

26. The code detection apparatus according to claim 17, wherein the code information comprises position information, system information, or recording medium information of the holographic data page.
